(19) United States
(12) Patent Application Publication
(10) Pub. No.: US 2013/0143151 A1
(43) Pub. Date: Jun. 6, 2013

(54) ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicants: Shinya NAKASHIMA, Kanagawa (JP); Masaru TAKAHASHI, Kanagawa (JP); Atsushi SUGITATE, Kanagawa (JP); Shotaro TAKAHASHI, Kanagawa (JP)

(72) Inventors: Shinya NAKASHIMA, Kanagawa (JP); Masaru TAKAHASHI, Kanagawa (JP); Atsushi SUGITATE, Kanagawa (JP); Shotaro TAKAHASHI, Kanagawa (JP)

(73) Assignee: FUJI XEROX CO., LTD., Tokyo (JP)

(21) Appl. No.: 13/454,597

(22) Filed: Apr. 24, 2012

(30) Foreign Application Priority Data
Dec. 5, 2011 (JP) 2011-266212

(51) Int. Cl. G03G 9/00; G03G 15/08

(52) U.S. Cl. 430/105; 399/252

(57) ABSTRACT

An electrostatic charge image developing toner includes: bright pigment particles; and a binder resin, and the electrostatic charge image developing toner has a main peak and at least one peak or shoulder that is higher in molecular weight than the main peak in a molecular weight distribution of a tetrahydrofuran-soluble component that is obtained through gel permeation chromatography measurement, and satisfies the following formula: 2≦A/B≦100, wherein A is reflectance at an acceptance angle of +30° that is measured when a solid image is formed using an electrostatic charge image developing toner and the image is irradiated with incident light at an incidence angle of −45° by the use of a variable-angle photometer, and B is reflectance at an acceptance angle of −30° that is measured when the image is irradiated with incident light at an incidence angle of −45° by the use of a variable-angle photometer.

### CROSS-REFERENCE TO RELATED APPLICATIONS

This application is based on and claims priority under 35 USC 119 from Japanese Patent Application No. 2011-266212 filed Dec. 5, 2011.

### BACKGROUND

1. Technical Field

The present invention relates to an electrostatic charge image developing toner, an electrostatic charge image developer, a toner cartridge, a process cartridge, an image forming apparatus, and an image forming method.

2. Related Art

Image formation using electrophotography is performed by forming a toner image through charging of the surface of a photoreceptor, exposure, and development and by transferring and fixing the toner image onto the surface of a recording medium.

The toner included in a developer for forming a toner image is selected in accordance with a target image. For example, when an image is formed that has a shine like metallic gloss, a bright toner is used.

### SUMMARY

According to an aspect of the invention, there is provided an electrostatic charge image developing toner including: bright pigment particles; and a binder resin, wherein the electrostatic charge image developing toner has a main peak and at least one peak or shoulder that is higher in molecular weight than the main peak in a molecular weight distribution of a tetrahydrofuran-soluble component that is obtained through gel permeation chromatography measurement, and satisfies the formula: 2≦A/B≦100, wherein A is reflectance at an acceptance angle of +30° that is measured when a solid image is formed using an electrostatic charge image developing toner and the image is irradiated with incident light at an incidence angle of −45° by the use of a variable-angle photometer, and B is reflectance at an acceptance angle of −30° that is measured when the image is irradiated with incident light at an incidence angle of −45° by the use of a variable-angle photometer.

### BRIEF DESCRIPTION OF THE DRAWINGS

Exemplary embodiments of the present invention will be described in detail based on the following figures, wherein:

FIG. 1 is a schematic diagram showing an incidence angle (−45°) and acceptance angles (+30°, −30°) when a reflectance ratio (A/B) with respect to a solid image is measured;

FIG. 2 is a cross-sectional view schematically showing an example of a toner particle according to an exemplary embodiment;

FIG. 3 is a schematic diagram showing an example of the configuration of an image forming apparatus according to the exemplary embodiment; and

FIG. 4 is a schematic diagram showing an example of the configuration of a process cartridge according to the exemplary embodiment.

### DETAILED DESCRIPTION

Hereinafter, exemplary embodiments of the invention will be described with reference to the accompanying drawings.

Electrostatic Charge Image Developing Toner

An electrostatic charge image developing toner (hereinafter, appropriately referred to as “toner”) according to this exemplary embodiment is a bright toner that includes bright pigment particles and a binder resin, satisfies the relationship in which when a solid image is formed, a ratio (A/B) of reflectance A at an acceptance angle of +30° to reflectance B at an acceptance angle of −30°, measured when the image is irradiated with incident light at an incidence angle of −45° by the use of a variable-angle photometer, is from 2 to 100, and has a main peak and at least one peak or shoulder that is higher in molecular weight than the main peak in a molecular weight distribution of a tetrahydrofuran-soluble component that is obtained through gel permeation chromatography measurement.

Here, the “brilliance” represents that when an image formed by the above toner is visually confirmed, the image has a shine like metallic gloss.

In order to realize a metallic glossy image, a bright metallic pigment in the image is oriented approximately horizontal to a sheet. In addition, the smaller and the lighter the image is, such as in gradation in the background and letters, the more it is necessary to strictly control the orientation of the pigment. Particularly, in the formation of a half-tone image such as gradation with metallic gloss, when a fixing temperature is reduced during continuous formation, the metallic pigment in a fixed image is not sufficiently oriented, and thus sufficient metallic gloss may not be obtained. On the other hand, when a fixing temperature is too high, a phenomenon in which a so-called isolated toner, that is not brought into contact with other toner particles in a toner image transferred onto a sheet, is adhered to a fixing roll from the sheet and fixed to another site in the sheet or the next sheet, that is, offset of the isolated toner occurs, and small deficiencies in the fixed image may occur.

The inventors of the invention have repeatedly conducted examinations and studies, and as a result, have found that when a bright toner is used that satisfies the relationship in which a reflectance ratio (A/B) with respect to the solid image is from 2 to 100 and has a main peak and at least one peak or shoulder that is higher in molecular weight than the main peak in a molecular weight distribution of a tetrahydrofuran-soluble component that is obtained through gel permeation chromatography measurement, sufficiently bright images are obtained and small deficiencies in the fixed image are suppressed even when half-tone images are continuously formed.

This mechanism is not clear, but inferred as follows.

In general, the amount of a metallic pigment per unit area is small in an image having a low toner density. Accordingly, when the metallic pigment is not more precisely oriented, sufficient brilliance may not be obtained. In addition, since the proportion of an isolated toner is high and an aggregating force between toner particles is weak in an image having a low toner density, offset of the isolated toner easily occurs.

However, since the toner according to this exemplary embodiment has a main peak that is low in molecular weight, it has meltability to sufficiently orient a metallic pigment in the fixing, and since the toner has a molecular weight distribution having a sub-peak or shoulder that is higher in molecular weight than the main peak, offset of the isolated toner is suppressed. Accordingly, even when half-tone images are continuously formed, the images may have sufficient brilliance and the occurrence of small image deficiencies may be suppressed.

Reflectance Ratio (A/B)

The fact that when a solid image is formed, a ratio (A/B) of reflectance A at an acceptance angle of +30° to reflectance B at an acceptance angle of −30°, measured when the image is irradiated with incident light at an incidence angle of −45° by the use of a variable-angle photometer, is 2 or higher represents that the reflectance toward the opposite side (+angle side) to the side to which the incident light is incident is higher (two times higher) than in the case of the reflection toward the side (−angle side) to which the incident light is incident, that is, represents that diffuse reflection of the incident light is suppressed. When diffuse reflection, in other words, reflection of the incident light in various directions, occurs, the reflected light is dulled in color when being visually confirmed. Therefore, when the ratio (A/B) is lower than 2, the gloss may not be confirmed and the brilliance deteriorates even when the reflected light is visually confirmed.

On the other hand, when the ratio (A/B) is higher than 100, the viewing angle at which the reflected light may be visually confirmed is too narrow and the positive reflected light component is large, whereby the reflected light looks blackish in accordance with the angle of view. In addition, a toner in which the ratio (A/B) is higher than 100 is not easily manufactured.

The ratio (A/B) is more preferably from 45 to 90 (or from about 45 to about 90), and particularly preferably from 60 to 80.

The ratio (A/B) is controlled by, for example, the stirring rotation speed when the toner is prepared by an emulsion aggregation method and the temperature of a melting coalescence process.

Here, measurement of the ratio (A/B) using a variable-angle photometer will be described.

In the measurement using a variable-angle photometer in this exemplary embodiment, the incident angle is set to −45°. The reason for this is that the measurement sensitivity for an image having a wide gloss degree range increases.

In addition, the reason for the acceptance angles of −30° and +30° is that the highest measurement sensitivity is achieved in evaluation of a bright image and a non-bright image.

In the measurement of the reflectance ratio (A/B), first, a “solid image” is formed by the following method. A developing machine DocuCentre-III C7600 manufactured by Fuji Xerox Co., Ltd is filled with a developer that is a sample, and a solid image with toner amount of 4.5 g/cm² is formed on a recording sheet (OK Top Coat+, manufactured by Oji Paper Co., Ltd) at a fixing temperature of 190° C. and a fixing pressure of 4.0 kg/cm². The “solid image” is an image in which the printing percentage is 100%.

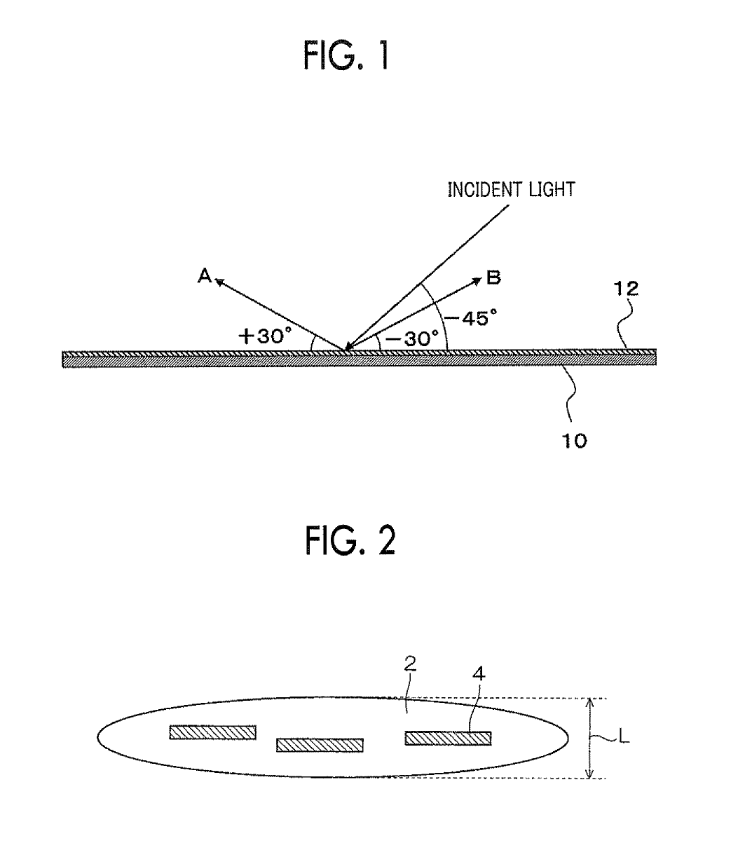

For example, as shown in FIG. 1, using a spectroscopic variable-angle colorimeter GC5000L manufactured by Nippon Denshoku Industries Co., Ltd as a variable-angle photometer, incident light at an angle of incidence to a solid image 12 of −45° is incident to an image portion of the solid image 12 formed on a recording sheet 10, and reflectance A at an acceptance angle of +30° and reflectance B at an acceptance angle of −30° are measured. Regarding the reflectance A and the reflectance B, light rays having a wavelength of from 400 nm to 700 nm are subjected to measurement at 20 nm intervals, and an average value of the reflectance at the respective wavelengths is employed. From the measurement results, the ratio (A/B) is calculated.

It is preferable that the toner according to this exemplary embodiment satisfy the following requirements (1) and (2) from the above-described viewpoint of satisfying the ratio (A/B).

(1) An average equivalent circle diameter D is longer than an average maximum thickness C of the toner.

(2) When the toner is observed in cross-section in a thickness direction, the number of pigment particles in which the angle between a long-axis direction in the cross-section of the toner and a long-axis direction of the pigment particles is from −30° to +30° is at least 60% of the observed total pigment particles.

Here, the requirements (1) and (2) will be described in detail. FIG. 2 schematically shows a cross-section in a thickness direction in an example of a toner satisfying the requirements (1) and (2). A toner 2 shown in FIG. 2 has a flat toner particle, of which the equivalent circle diameter is longer than a thickness L, and contains flake-shape bright pigment particles 4.

Average Maximum Thickness C and Average Equivalent Circle Diameter D

It is preferable that the average equivalent circle diameter D be longer than the average maximum thickness C in the toner according to this exemplary embodiment. Specifically, a ratio (C/D) of the average maximum thickness C to the average equivalent circle diameter D is preferably in the range of from 0.001 to 0.500, more preferably from 0.010 to 0.200, and particularly preferably from 0.050 to 0.100.

When the ratio (C/D) of the average maximum thickness C to the average equivalent circle diameter D is 0.001 or higher, the strength of the toner is secured, fracture due to the stress in the image formation is suppressed, charging due to pigment exposure is reduced, and as a result, the occurrence of fogging is suppressed. When the ratio (C/D) is 0.500 or lower, excellent brilliance is obtained.

The average maximum thickness C and the average equivalent circle diameter D are measured by the following method.

A toner is put on a flat surface and vibration is applied thereto to disperse the toner without unevenness. 1,000 toner particles are magnified by a factor of 1,000 using a color laser microscope “VK-9700” (manufactured by Keyence Corporation) to measure a maximum thickness C and an equivalent circle diameter D of the surface viewed from above. By computing the arithmetic mean values thereof, the average maximum thickness C and the average equivalent circle diameter D are calculated. The equivalent circle diameter is calculated as a diameter of the circle having the same area as the area of the two-dimensional image in each of the particles.

Angle Between Long-Axis Direction in Cross-Section of Toner and Long-Axis Direction of Pigment Particles

As shown in FIG. 2, when the toner particle 2 has a flat shape, of which the equivalent circle diameter is longer than the thickness L, in the movement of the toner to an image holding member, an intermediate transfer member, a recording medium and the like in a developing process and a transfer process for image formation, there is a tendency for the toner to be moved so as to maximally cancel the charge of the toner. Accordingly, the toner particles may be arranged so that the area of adhesion to a recording medium or the like is the largest. That is, on a recording medium onto which the toner is finally transferred, the flat toner particles may be arranged so that the flat sides thereof face the surface of the recording medium. In addition, in a fixing process for image formation, by a pressure during the fixing, the flat toner particles may also be arranged so that the flat sides thereof face the surface of the recording medium.

Therefore, the pigment particles satisfying the requirement the angle between a long-axis direction in the cross-section of the toner and a long-axis direction of the pigment particles is from −30° to +30°″ shown in the above (2) among the flake-shape pigment particles contained in the toner may be arranged so that the sides thereof in which the area is the maximum face the surface of the recording medium. When the image formed in this manner is irradiated with light, a ratio of the pigment particles diffusively reflecting the incident light is suppressed, and thus the range of the ratio (A/B) may be satisfied.

Here, a toner cross-section observing method will be described.

The toner is embedded using a bisphenol A-type liquid epoxy resin and a curing agent, and then a sample for cutting is prepared. Next, using a cutter (in this exemplary embodiment, using a LEICA ultramicrotome (manufactured by Hitachi High-Technologies Corporation)) using a diamond knife, the cutting sample is cut at −100° C. to prepare a sample for observation. The sample for observation is observed in cross-section of toner particles at about 5,000-fold magnification using a transmission electron microscope (TEM). In the 1,000 toner particles observed, the number of pigment particles in which the angle between a long-axis direction in the cross-section of the toner and a long-axis direction of the pigment particles is from −30° to +30° is counted using image analysis software and a ratio thereof is calculated.

The “long-axis direction in the cross-section of the toner” represents a direction perpendicular to the thickness direction in the above-described toner in which the average equivalent circle diameter D is longer than the average maximum thickness C. The “long-axis direction of the pigment particles” represents a length direction in the pigment particles.

As described above, in the toner according to this exemplary embodiment, it is preferable that when the toner is observed in cross-section in a thickness direction, the number of pigment particles in which the angle between a long-axis direction in the cross-section of the toner and a long-axis direction of the pigment particles is from −30° to +30° be at least 60% (or at least about 60%) of the observed total pigment particles. The number of pigment particles is more preferably from 70% to 95%, and particularly preferably from 80% to 90%.

When the number of pigment particles is at least 60%, excellent brilliance is obtained.

Molecular Weight Distribution

The toner according to this exemplary embodiment has a main peak and at least one peak or shoulder that is higher in molecular weight than the main peak in a molecular weight distribution of a tetrahydrofuran (appropriately called “THF”)-soluble component that is obtained through gel permeation chromatography (appropriately called “GPC”) measurement.

Specifically, in this exemplary embodiment, for the molecular weight of the THF-soluble component that is obtained through the GPC measurement, an HLC-8120 manufactured by TOSOH Corporation is used for GPC, a TSEgeI Super HM-M column (15 cm) manufactured by Tosoh Corporation is used, and a tetrahydrofuran (THF) solvent is used for measurement, and the molecular weight is calculated by using a molecular weight calibration curve created using a monodisperse polystyrene standard sample.

The “peak” in the molecular weight distribution that is obtained through the above-described GPC measurement means a portion corresponding to a mountain shape that may describe a curve in the vertical direction which recurs in the differential molecular weight distribution curve (chart curve) that is obtained through the GPO measurement. The “shoulder” means a portion corresponding to an inflection point that may not describe a curve in the vertical direction which recurs in the chart curve. In addition, the “main peak” means a peak with the longest vertical axis (value obtained by differentiating a concentration fraction by a logarithmic value of the molecular weight) among the peaks in the chart curve.

Since the toner according to this exemplary embodiment has, other than a main peak, at least one peak or shoulder that is higher in molecular weight than the main peak in the above-described molecular weight distribution, the occurrence of offset of the isolated toner may be suppressed and the occurrence of small image deficiencies may be suppressed.

More specifically, regarding the molecular weight distribution of the toner according to this exemplary embodiment, it is preferable that the molecular weight distribution of the THF-soluble component that is obtained through the GPO measurement have a main peak in a molecular weight range of from 7,000 to 20,000 and at least one peak or shoulder other than the main peak in a molecular weight range of 100,000 or more, and a weight ratio of the component distributed in a molecular weight range of from 100,000 to 1,000,000 is from 7% to 20%.

Molecular Weight at Main Peak

In the toner according to this exemplary embodiment, since the molecular weight at the main peak that is obtained through the GPC measurement is 7,000 or greater, the occurrence of offset of the isolated toner in image fixing is effectively suppressed, and since the molecular weight is 20,000 or less, the metallic pigment is sufficiently oriented and the brilliance is thus sufficiently exhibited. Particularly, from the viewpoint that the brilliance is particularly sufficiently exhibited even when the image density is low, the range of the molecular weight at the main peak that is obtained through the GPC measurement is more preferably from 8,000 to 19,000, even more preferably from 9,000 to 17,000, and particularly preferably from 10,000 to 15,000.

Peak or Shoulder that is Higher in Molecular Weight than Main Peak

In addition, since the peak or shoulder that is higher in molecular weight than the main peak in the GPC measurement is in a molecular weight range of 100,000 or more, the occurrence of offset of the isolated toner in image fixing is effectively suppressed. From such a viewpoint, the peak or shoulder other than the main peak is more preferably in a molecular weight range of from 150,000 to 1,100,000, and even more preferably from 250,000 to 800,000.

It is preferable that the number of peaks or shoulders that are higher in molecular weight than the main peak is from 1 to 3.

Weight Ratio of High Molecular Weight Region

Furthermore, when the image density is yet lower, in addition to the molecular weight at the peak or shoulder, the proportion of the component included in a high molecular weight region is important to exhibit brilliance. Since a weight ratio of the component having a distribution in a molecular weight range of from 100,000 to 1,000,000 is 7% or higher, a reduction in brilliance due to image roughness resulting from the offset of the isolated toner is suppressed, and since the weight ratio is 20% or lower, the metallic pigment is sufficiently oriented even when the image density is low, and thus brilliance is sufficiently exhibited.

The weight ratio of the component having a distribution in a molecular weight range of from 100,000 to 1,000,000 in the GPC measurement is more preferably from 10% to 15%.

For example, when polyester is used as a binder resin, the molecular weight distribution is controlled by molecular weights of two or more types of resins having different molecular weights and a mixing ratio. In the preparation of the toner according to this exemplary embodiment by, for example, an emulsion aggregation method, by preparing a resin particulate dispersion using a simultaneous emulsification method, the compatibility at a molecular level increases and a desired molecular weight distribution is obtained.

When styrene acryl is used as a binder resin, a desired molecular weight distribution is obtained by controlling the molecular weight with the amount of a reaction initiator and a chain transfer agent in the resin preparation and by adjusting the amount of a crosslinking agent added that has a long alkyl chain length (preferably, the carbon number is 10 or more).

Next, the components of the toner according to this exemplary embodiment will be described in detail. The toner according to this exemplary embodiment includes bright pigment particles and a binder resin, and if necessary, an additive and the like.

Bright Pigment Particles

Examples of the bright pigment particles included in the toner according to this exemplary embodiment include, but are not particularly limited to as long as the pigment particles have brilliance, powders of metals such as aluminum, brass, bronze, nickel, stainless steel and zinc; coated flaky inorganic crystal substrates such as mica, barium sulfate, a layer silicate and a layer aluminum silicate that are coated with titanium oxide or yellow iron oxide; single-crystal plate-like titanium oxide; basic carbonate; bismuth oxychloride; natural guanine; flaky glass powder; and metal-deposited flaky glass powder. Among them, aluminum having high brilliance may be preferably used.

The content of the pigment in the toner according to this exemplary embodiment is preferably from 1 part by weight to 70 parts by weight, and more preferably from 5 parts by weight to 50 parts by weight with respect to 100 parts by weight of the toner.

Binder Resin

Examples of the binder resin included in the toner according to this exemplary embodiment include ethylene-based resins such as polyester, polyethylene and polypropylene; styrene-based resins such as polystyrene and α-polymethylstyrene; (meth)acryl-based resins such as polymethyl methacrylate and polyacrylonitrile; polyimide resins; polycarbonate resins; polyether resins; and copolymer resins thereof. Among them, polyester resins are preferably used.

Hereinafter, polyester resins that are particularly preferably used will be described.

The polyester resins that are used in the toner according to this exemplary embodiment may be obtained by, for example, polycondensation of polyvalent carboxylic acids and polyols.

Examples of the polyvalent carboxylic acid include aromatic carboxylic acids such as terephthalic acid, sophthalic acid, phthalic anhydride, trimellitic anhydride, pyromellitic acid and naphthalenedicarboxylic acid; aliphatic carboxylic acids such as maleic anhydride, fumaric acid, succinic acid, alkenyl succinic anhydride and adipic acid; and alicyclic carboxylic acids such as cyclohexanedicarboxylic acid. These polyvalent carboxylic acids are used singly or in combination of two or more types.

Among the polyvalent carboxylic acids, aromatic carboxylic acids are preferably used. Furthermore, to employ a cross-linked structure or a branched structure in order to secure good fixability, it is preferable that a tri- or higher-valent carboxylic acid (such as trimellitic acid or an anhydride thereof) be used in combination with a dicarboxylic acid.

Examples of the polyol include aliphatic diols such as ethylene glycol, diethylene glycol, triethylene glycol, propylene glycol, butanediol, hexanediol, neopentyl glycol and glycerol; alicyclic diols such as cyclohexanediol, cyclohexanedimethanol and hydrogenated bisphenol A; and aromatic diols such as ethylene oxide adducts of bisphenol A and propylene oxide adducts of bisphenol A. These polyols are used singly or in combination of two or more types.

Among the polyols, aromatic diols and alicyclic diols are preferably used. Among them, aromatic diols are more preferably used. Furthermore, to employ a cross-linked structure or a branched structure in order to secure better fixability, a tri- or higher-valent polyol (such as glycerol, trimethylolpropane, or pentaerythritol) may also be used in combination with a diol.

The method of manufacturing the polyester resin is not particularly limited, and the polyester resin is manufactured by a normal polyester polymerization method in which an acid component and an alcohol component are allowed to react with each other. For example, the polyester resin is manufactured by properly employing direct polycondensation, an ester interchange method, or the like depending on the types of monomers. The molar ratio (acid component/alcohol component) in the reaction between the acid component and the alcohol component varies with the reaction conditions and the like, and thus may not be defined with certainty. However, in general, the molar ratio is preferably about 1/1 to achieve a high molecular weight.

Examples of a catalyst that may be used in the manufacturing of the polyester resin include compounds of alkali metals such as sodium and lithium; compounds of alkaline earth metals such as magnesium and calcium; compounds of metals such as zinc, manganese, antimony, titanium, tin, zirconium, and germanium; phosphorous acid compounds; phosphoric acid compounds; amine compounds; and tetrabutoxy titanate.

Release Agent

The toner according to this exemplary embodiment may contain a release agent if necessary. Examples of the release agent include paraffin wax such as low-molecular weight polypropylene and low-molecular weight polyethylene, silicone resins, rosins, rice wax, and carnauba wax. The melting temperature of the release agent is preferably from 50° C. to 100° C., and more preferably from 60° C. to 95° C.

The content of the release agent in the toner is preferably from 0.5% by weight to 15% by weight, and more preferably from 1.0% by weight to 12% by weight.

Other Additives

Besides the components described above, various components such as an internal additive, a charge-controlling agent, an inorganic powder (inorganic particles) and organic particles may also be incorporated into the toner according to this exemplary embodiment if necessary.

Examples of the charge-controlling agent include quaternary ammonium salt compounds, nigrosine-based compounds, dyes composed of a complex of aluminum, iron, chromium and the like, and triphenylmethane-based pigments.

Examples of the inorganic particles include known inorganic particles such as silica particles, titanium oxide particles, alumina particles, cerium oxide particles, and particles obtained by hydrophobizing the surfaces of the above particles. These known inorganic particles may be used singly or in combinations of two or more types. Among them, silica particles, that have a refractive index lower than that of the above-described binder resin, are preferably used. The silica particles may be subjected to a surface treatment. For example, silica particles surface-treated with a silane-based coupling agent, a titanium-based coupling agent, silicone oil, or the like are preferably used.

In addition, the volume average particle diameter of the toner according to this exemplary embodiment is preferably from 1 μm to 30 μm, more preferably 3 μm to 20 μm, and even more preferably from 5 μm to 10 μm.

The volume average particle diameter D₅₀ is determined as follows. A cumulative distribution is drawn from the smallest diameter side for the respective volume and number in the particle size ranges (channels) divided on the basis of a particle size distribution measured with a measuring machine such as a Multisizer II (manufactured by Beckman Coulter Inc.). The particle diameter corresponding to 16% in the cumulative distribution is defined as that corresponding to volume D₁₆ᵥ and number D₁₅ₚ, the particle diameter corresponding to 50% in the cumulative distribution is defined as that corresponding to volume D₅₀ᵥ and number D₅₀ₚ, and the particle diameter corresponding to 84% in the cumulative distribution is defined as that corresponding to volume D₈₄ᵥ and number D₈₄ₚ. Using the above values, the volume average particle size distribution index (GSDv) is calculated as (D₈₄ᵥ/D₁₆ᵥ)^{1/2}.

Toner Manufacturing Method

Examples of the method of manufacturing the toner according to this exemplary embodiment include, in order to control the molecular weight distribution that is obtained through the GPC measurement, a method of preparing toner particles using appropriate amounts of plural resins having different molecular weights. The toner according to this exemplary embodiment is prepared by a known method such as a wet method or a dry method, and particularly, it is preferable that the toner according to this exemplary embodiment be manufactured by a wet method. Examples of the wet method include a melt suspension method, an emulsion aggregation method, and a dissolution suspension method. Among them, an emulsion aggregation method is particularly preferably employed.

Here, the emulsion aggregation method is a method including: preparing dispersions (such as an emulsion and a pigment dispersion) each containing a component (such as a binder resin and a pigment) included in the toner; mixing the dispersions to prepare a mixed liquid; and heating the resultant aggregated particles to the melting temperature or the glass transition temperature of the binder resin or higher (in the manufacturing of a toner containing both a crystalline resin and an amorphous resin, to a temperature equal to or higher than the melting temperature of the crystalline resin and equal to or higher than the glass transition temperature of the amorphous resin) to aggregate the toner components and cause the toner components to coalesce.

A composite resin particle dispersion in which plural resins are mixed and combined is made in the preparation of the resin particle dispersion that is used in the emulsion aggregation method, and thus a toner is obtained in which uneven distribution of the resin components in the toner is suppressed and the effect of suppressing the occurrence of offset of the isolated toner is sufficiently exhibited.

For example, when the binder resin is polyester, it is preferable that a phase inversion emulsification method be used in adjustment of the composite resin particle dispersion from the viewpoint of particle diameter control.

The phase inversion emulsification method is a method in which a resin to be dispersed is dissolved in a hydrophobic organic solvent in which the resin is soluble, a base is added to the organic continuous phase (O-phase) to neutralize, and an aqueous medium (W-phase) is then poured, and thus conversion (so-called phase inversion) of the resin from W/O to O/W occurs, whereby a discontinuous phase is formed and the resin is dispersed and stabilized in the aqueous medium in a particulate form. The phase inversion emulsification method may also be used when a resin dispersion is adjusted using a binder resin other than the polyester resin.

Examples of the organic solvent used in the phase inversion emulsification include alcohols such as ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol and cyclohexanol, ketones such as methyl ethyl ketone, methyl isobutyl ketone, ethyl butyl ketone, cyclohexanone and isophorone, ethers such as tetrahydrofuran, dimethyl ether, diethyl ether and dioxane, esters such as methyl acetate, ethyl acetate, n-propyl acetate, isopropyl acetate, n-butyl acetate, isobutyl acetate, sec-butyl acetate, 3-methoxybutyl acetate, methyl propionate, ethyl propionate, butyl propionate, dimethyl oxalate, diethyl oxalate, dimethyl succinate, diethyl succinate, diethyl carbonate and dimethyl carbonate, glycol derivatives such as ethylene glycol, ethylene glycol monomethyl ether, ethylene glycol monoethyl ether, ethylene glycol monopropyl ether, ethylene glycol monobutyl ether, ethylene glycol ethyl ether acetate, diethylene glycol, diethylene glycol monomethyl ether, diethylene glycol monoethyl ether, diethylene glycol monopropyl ether, diethylene glycol monobutyl ether, diethylene glycol ethyl ether acetate, propylene glycol, propylene glycol monomethyl ether, propylene glycol monoethyl ether, propylene glycol monopropyl ether, propylene glycol monobutyl ether, propylene glycol methyl ether acetate and dipropylene glycol monobutyl ether, 3-methoxy-3-methylbutanol, 3-methoxybutanol, acetonitrile, dimethyl formamide, dimethyl acetamide, diacetone alcohol, and ethyl acetoacetate. These solvents may be used singly or in combination of two or more types.

Regarding the amount of the organic solvent used in the phase inversion emulsification, the amount of the solvent for obtaining a desired dispersed particle diameter varies with the physical properties of the resin, and thus in general, it is difficult to define the amount of the solvent with certainty. When the amount of the solvent is small, the emulsifying property becomes insufficient, and thus the particle diameter of resin particles may increase or the particle size distribution may broaden.

When the binder resin is dispersed in water, a carboxyl group in the resin may be partially or entirely neutralized using a neutralizer if necessary. Examples of the neutralizer include inorganic alkalis such as potassium hydroxide and sodium hydroxide, and amines such as ammonia, monomethylamine, dimethylamine, triethylamine, monoethylamine, diethylamine, mono-n-propylamine, dimethyl-n-propylamine, monoethanolamine, diethanolamine, triethanolamine, N-methylethanolamine, N-aminoethylethanolamine, N-methyldiethanolamine, monoisopropanolamine, diisopropanolamine, triisopropanolamine, N,N-dimethylpropanolamine. One or two or more types of them may be selected and used.

The amount of the solvent used in the phase inversion emulsification is adjusted by the melt viscosity of the resin, and the amount of the neutralizer is adjusted by the acid value of the resin. By adding the neutralizer, the pH in the emulsification is adjusted to be neutral, and hydrolysis of the obtained polyester resin dispersion is prevented.

Furthermore, a dispersant may be added for the purpose of stabilizing the dispersed particles or preventing an increase in viscosity of the aqueous medium in the phase inversion emulsification. Examples of the dispersant include water-soluble polymers such as polyvinyl alcohol, methyl cellulose, ethyl cellulose, hydroxyethyl cellulose, carboxymethyl cellulose, sodium polyacrylate and sodium polymethacrylate. These dispersants may be used singly or in combination of two or more types. The dispersant may be added in an amount of from 0.01 part by weight to 20 parts by weight with respect to 100 parts by weight of the binder resin.

The emulsification temperature in the phase inversion emulsification may be equal to or lower than the boiling point of the organic solvent, and equal to or higher than the melting temperature or the glass transition temperature of the binder resin. When the emulsification temperature is lower than the melting temperature or the glass transition temperature of the binder resin, it is difficult to adjust the resin dispersion. When the emulsification is performed at a temperature equal to or higher than the boiling point of the organic solvent, the emulsification may be performed in a pressurized and sealed device.

Generally, the content of the resin particles included in the resin dispersion may be from 5% by weight to 50% by weight, or from 10% by weight to 40% by weight. When the content is inside the above ranges, the particle size distribution of the resin particles may be narrowed and the characteristics may improve.

In addition, the resin dispersion may be prepared by giving a shearing force to a mixture solution of the aqueous medium and the resin by a dispersing machine. At this time, the viscosity of the resin components may be lowered by heating to form particles. In addition, a dispersant may be used to stabilize the dispersed resin particles.

Examples of the aqueous medium include water such as distilled water and ion exchange water; and alcohols. Water alone is preferably used.

Examples of the dispersant include water-soluble polymers such as polyvinyl alcohol, methylcellulose, ethylcellulose, hydroxyethyl cellulose, carboxymethyl cellulose, sodium polyacrylate and sodium polymethacrylate.

Examples of the dispersing machine that is used in the preparation of the resin dispersion include a homogenizer, a homomixer, a pressure kneader, an extruder, and a media dispersing machine.

As for the size of the resin particles, the average particle diameter thereof (volume average particle diameter) is preferably 1.0 μm or less, more preferably in the range of from 60 nm to 300 nm, and even more preferably in the range of from 150 nm to 250 nm. When the volume average particle diameter is not less than 60 nm, the resin particles become slightly unstable particles in the dispersion, and thus the resin particles may be easily aggregated. In addition, when the volume average particle diameter is not greater than 1.0 μm, the particle size distribution of the toner may be narrowed.

As described above, in this exemplary embodiment, it is preferable that a toner meet the above-described requirements (1) and (2). When the toner is manufactured by the emulsion aggregation method, the toner may be prepared by, for example, the following manufacturing method.

First, pigment particles are prepared, and the pigment particles are mixed with a binder resin by dispersing and dissolving in a solvent. The mixture is dispersed in water by phase inversion emulsification or shear emulsification to form bright pigment particles coated with the resin. Other compositions (e.g., a release agent and a resin for a shell) are added, and an aggregating agent is further added thereto. The temperature is increased to near the glass transition temperature (Tg) of the resin under stirring to form aggregated particles.

As the aggregating agent, a di- or higher-valent metal complex is preferably used as well as a surfactant having a polarity opposite to that of a surfactant used in the dispersant and inorganic metallic salt. Particularly, a metal complex is particularly preferably used because the amount of the surfactant used is reduced and charging characteristics are improved.

As the inorganic metallic salt, aluminum salt and its polymer are particularly preferably used.

In this process, by stirring at a high stirring rate (for example, from 500 rpm to 1500 rpm) using, for example, a stirring blade with two paddles that forms a laminar flow, the bright pigment particles are aligned within the aggregated particles in the long-axis direction thereof, and the aggregated particles are also aggregated in the long-axis direction. Thus, the thickness of the toner is reduced (that is, the above-described requirement (1) is satisfied).

Finally, the pH is adjusted to be alkaline in order to stabilize the particles, and the temperature is then increased to the glass transition temperature (Tg) or higher but not higher than the melting temperature (Tm) of the toner to cause the aggregated particles to coalesce. In this coalescence process, by causing the aggregated particles to coalesce at lower temperature (for example, from 60° C. to 80° C.), the movement of the materials caused by the rearrangement thereof is suppressed, and the orientation of the pigment is kept. Thus, a toner that satisfies the above-described requirement (2) is obtained.

The stirring rate is more preferably from 650 rpm to 1130 rpm, and particularly preferably from 760 rpm to 870 rpm. In addition, the coalescence temperature in the coalescence process is more preferably from 63° C. to 75° C., and particularly preferably from 65° C. to 70° C.

External Additive

In this exemplary embodiment, external additives such as a fluidizer and an aid may be added to treat the surfaces of the toner particles. Examples of the external additive include known particles such as inorganic particles, e.g., silica particles, titanium oxide particles, alumina particles, cerium oxide particles, and carbon black, and polymer particles, e.g., polycarbonate particles, polymethyl methacrylate particles, and silicone resin particles, the surfaces of which are subjected to a hydrophobization treatment.

Developer

The toner according to this exemplary embodiment may be used as a single-component developer as it is or as a two-component developer by being mixed with a carrier.

The carrier that may be used in a two-component developer is not particularly limited, and known carriers may be used. Examples thereof include magnetic metals such as iron oxide, nickel and cobalt, magnetic oxides such as ferrite and magnetite, resin-coated carriers having a resin coating layer on the surfaces of the core materials, and magnetic dispersion carriers. In addition, the carrier may be a resin-coated carrier in which a conductive material or the like is dispersed in a matrix resin.

Examples of the core material of the carrier include magnetic metals such as iron, nickel and cobalt, magnetic oxides such as ferrite and magnetite, and glass beads. In order to use the carrier in a magnetic brush method, it is preferable that the carrier be made of a magnetic material. The core material of the carrier generally has a volume average particle diameter in the range of from 10 μm to 500 μm, and preferably from 30 μm to 100 μm.

Examples of the coating resin and the matrix resin used in the carrier include, but are not limited to, polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylic acid copolymers, straight silicone resins having an organosiloxane bond and modified resins thereof, fluororesin, polyester, polycarbonate, phenolic resins, and epoxy resins.

Examples of the conductive material include, but are not limited to, metals such as gold, silver and copper, carbon black, titanium oxide, zinc oxide, barium sulfate, aluminum borate, potassium titanate, and tin oxide.

Examples of the method of coating the surface of the core material of the carrier with a resin include a coating method using a solution for forming a coating layer that is prepared by dissolving the coating resin, and if necessary, various additives in an appropriate solvent. The solvent is not particularly limited, and may be selected in view of the coating resin used, application suitability, and the like.

Specific examples of the resin coating method include a dipping method in which a core material of the carrier is dipped in a solution for forming a coating layer, a spray method in which a solution for forming a coating layer is sprayed onto the surface of a core material of the carrier, a fluidized bed method in which a solution for forming a coating layer is sprayed in a state in which a core material of the carrier is allowed to float with flowing air, and a kneader coater method in which a core material of the carrier and a solution for forming a coating layer are mixed in a kneader coater and the solvent is then removed.

The mixing ratio (weight ratio) of the toner according to this exemplary embodiment and the carrier in the two-component developer (toner:carrier) is preferably from 1:100 to 30:100, and more preferably from 4:100 to 20:100.

Image Forming Apparatus

An image forming apparatus according to this exemplary embodiment includes an image holding member, a charging unit that charges a surface of the image holding member, a latent image forming unit that forms an electrostatic latent image on the surface of the image holding member, a developing unit that develops the electrostatic latent image formed on the surface of the image holding member by using a developer to form a toner image, and a transfer unit that transfers the developed toner image onto a transfer member, wherein the developer is the electrostatic charge image developer according to this exemplary embodiment.

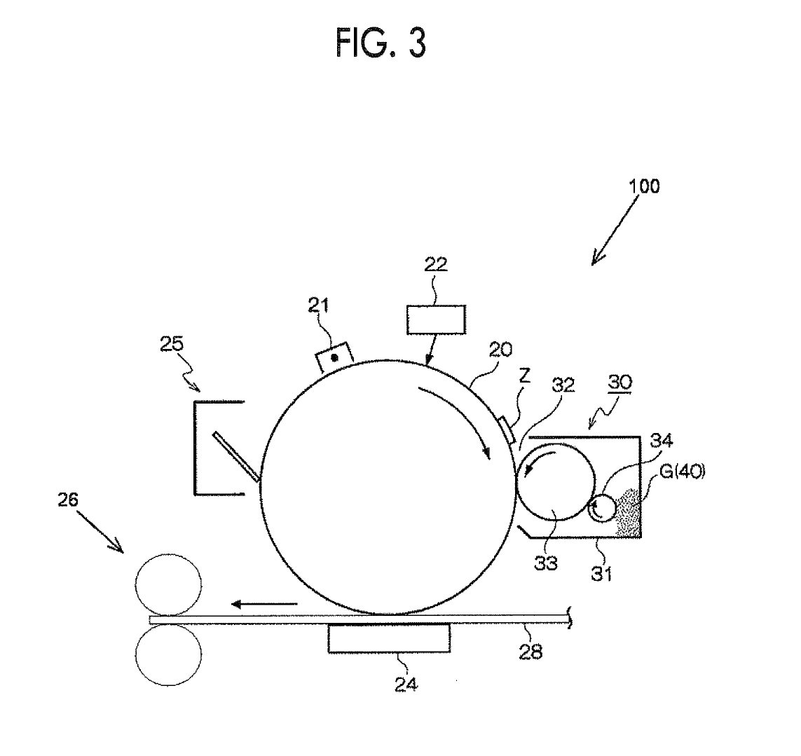

FIG. 3 schematically shows an example of the configuration of an image forming apparatus including a developing device to which the toner according to this exemplary embodiment is applied.

An image forming apparatus 100 according to this exemplary embodiment is provided with a photoreceptor drum 20 as an image holding member that rotates in a predetermined direction, a charging device 21 that charges the photoreceptor drum 20, an exposure device 22 as a latent image forming device that forms an electrostatic latent image Z on the charged photoreceptor drum 20, a developing device 30 that visualizes the electrostatic latent image Z formed on the photoreceptor drum 20 as a toner image, a transfer device 24 that transfers the toner image formed on the photoreceptor drum 20 onto a recording sheet 28 that is a transfer member, a cleaning device 25 that cleans up the residual toner on the photoreceptor drum 20, and a fixing device 26 that fixes the toner image transferred onto the recording sheet 28.

In this exemplary embodiment, the developing device 30 includes a developing housing 31 that accommodates a developer G containing a toner 40. In this developing housing 31, an opening 32 for development is opened so as to be opposed to the photoreceptor drum 20, and a developing roll (developing electrode) 33 as a toner holding member is provided so as to face the opening 32 for development. By applying a predetermined developing bias to the developing roll 33, a development field is formed in a developing region sandwiched between the photoreceptor drum 20 and the developing roll 33. Furthermore, a charge injection roll (injection electrode) 34 as a charge injection member is provided in the developing housing 31 so as to be opposed to the developing roll 33. The charge injection roll 34 also functions as a toner supply roll for supplying the toner 40 to the developing roll 33.

The rotation direction of the charge injection roll 34 may be appropriately selected. Considering a toner supply property and a charge injection property, it is preferable that the charge injection roll 34 rotate in the same direction as the developing toll 33 at a position at which the charge injection roll 34 is opposed to the developing roll 33 with a difference in the peripheral speed (for example, 1.5 times or more), the toner 40 be sandwiched in a region sandwiched between the charge injection roll 34 and the developing roll 33, and a charge be injected through sliding friction.

Next, the operation of the image forming apparatus according to the exemplary embodiment will be described.

When an image forming process is started, first, the surface of the photoreceptor drum 20 is charged by the charging device 21, the exposure device 22 forms an electrostatic latent image Z on the charged photoreceptor drum 20, and the developing device 30 visualizes the electrostatic latent image Z as a toner image. Subsequently, the toner image on the photoreceptor drum 20 is transported to a transfer site, and the transfer device 24 electrostatically transfers the toner image on the photoreceptor drum 20 onto the recording sheet 28 that is a transfer member. The residual toner on the photoreceptor drum 20 is cleaned up with the cleaning device 25. After transfer, the toner image on the recording sheet 28 is fixed by the fixing device to obtain an image.

In this exemplary embodiment, the fixing temperature is preferably from 150° C. to 200° C., and the fixing pressure is preferably from 1.5 kg/cm² to 5.0 kg/cm².

Process Cartridge and Toner Cartridge

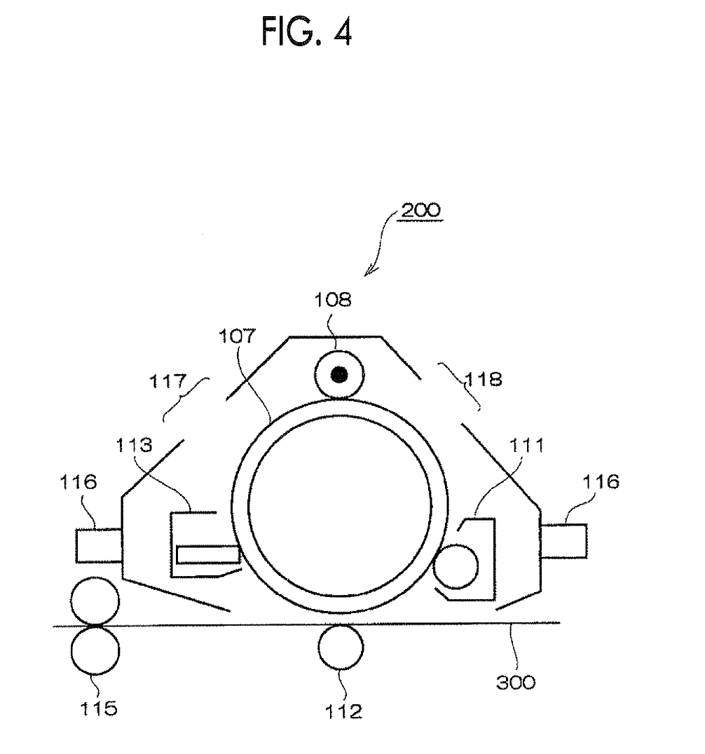

FIG. 4 is a diagram schematically showing the configuration of an example of a process cartridge according to this exemplary embodiment. The process cartridge according to this exemplary embodiment accommodates the above-described toner according to this exemplary embodiment and includes a toner holding member that holds and transports the toner.

A process cartridge 200 shown in FIG. 4 is assembled by integrally combining a charging roller 108, a developing device 111 that accommodates the above-described toner according to this exemplary embodiment, a photoreceptor cleaning device 113, an opening portion 118 for exposure, and an opening portion 117 for erasing exposure by the use of a mounting rail 116, together with a photoreceptor 107 as an image holding member. The process cartridge 200 is detachable from the body of an image forming apparatus including a transfer device 112, a fixing device 115, and other constituent portions (not shown). The process cartridge 200 constitutes the image forming apparatus together with the body of the image forming apparatus.

The process cartridge 200 shown in FIG. 4 is provided with the charging roller 108, the developing device 111, the cleaning device 113, the opening portion 118 for exposure, and the opening portion 117 for erasing exposure. However, these devices may be selectively combined. The process cartridge according to this exemplary embodiment employs a configuration provided with the developing device 111 and at least one selected from the group consisting of the photoreceptor 107, the charging roller 108, the cleaning device (cleaning unit) 113, the opening portion 118 for exposure, and the opening portion 117 for easing exposure.

Next, a toner cartridge according to this exemplary embodiment will be described. The toner cartridge according to this exemplary embodiment is detachably mounted on an image forming apparatus and accommodates the above-described toner according to this exemplary embodiment to supply the toner to a developing unit provided in the image forming apparatus. The toner cartridge according to this exemplary embodiment may accommodate at least the toner according to this exemplary embodiment, and depending on the structure of the image forming apparatus, may accommodate a developer in which the toner according to this exemplary embodiment is mixed with a carrier.

The image forming apparatus shown in FIG. 3 has a configuration in which a toner cartridge (not shown) is detachably mounted, and the developing device 30 is connected to the toner cartridge through a toner supply tube (not shown). In addition, when the toner accommodated in the toner cartridges runs low, the toner cartridge may be replaced.

Image Forming Method

An image forming method according to this exemplary embodiment includes charging a surface of an image holding member, forming an electrostatic latent image on the surface of the image holding member, developing the electrostatic latent image formed on the surface of the image holding member by using a developer to form a toner image, and transferring the developed toner image onto a transfer member, wherein the developer is the electrostatic charge image developer according to this exemplary embodiment.

### Examples

Hereinafter, the invention will be described in detail with examples, but is not limited to the examples. In the following description, “parts” and “%” are based on weight unless particular notice is given.

Synthesis of Binder Resin 1
Bisphenol A-Propylene Oxide Adduct: 469 parts
Bisphenol A-Ethylene Oxide Adduct: 137 parts
Terephthalic Acid: 152 parts
Fumaric Acid: 75 parts
Dibutyltin Oxide: 4 parts
Dodecenyl Succinic Acid: 114 parts

The above components are put into a heated and dried three-necked flask. Then, the air pressure in the container is reduced by a pressure reduction operation and an inert atmosphere is provided using nitrogen gas. The components are reacted for 10 hours at a normal pressure (101.3 kPa) and a temperature of 230° C. by mechanical stirring, and further reacted for 1 hour at 8 kPa. The reaction product is cooled to 210° C., 4 parts by weight of trimellitic anhydride are added thereto and reacted for 1 hour, and then reacted at 8 kPa until the softening temperature becomes 107° C. Thus, a binder resin 1 is obtained.

As for the softening temperature of the resin, using a Flow Tester (manufactured by Shimadzu Corporation, CFT-5000), 1 g of a sample is heated at a rate of temperature increase of 6° C./min, and a load of 1.96 MPa is applied by a plunger to push out the sample from a nozzle having a diameter of 1 mm and a length of 1 mm. A temperature at which half of the sample flows out is set as the softening temperature.

Synthesis of Binder Resins 1 to 20

Binder resins 2 to 20 are obtained in the same manner as in the case of the binder resin 1, except that the amount of the monomer component added and the softening temperature at the time of resin extraction are changed as in Table 1.

TABLE 1

| | Bisphenol | Bisphenol | | | | | |
|---|---|---|---|---|---|---|---|
| | A-Propylene Oxide | A-Ethylene Oxide | Terephthalic | Trimellitic | Fumaric | Dodecenyl Succinic | Resin Softening |
| | Adduct | Adduct | Acid | Anhydride | Acid | Acid | Temperature |
| | (parts) | (parts) | (parts) | (parts) | (parts) | (parts) | (° C.) |
| Binder Resin 1 | 469 | 137 | 152 | 4 | 75 | 114 | 107 |
| Binder Resin 2 | 367 | 230 | 163 | 20 | 12 | 227 | 118 |
| Binder Resin 3 | 469 | 137 | 152 | 4 | 75 | 114 | 111 |
| Binder Resin 4 | 163 | 416 | 294 | 20 | 12 | 0 | 111 |
| Binder Resin 5 | 367 | 230 | 278 | 20 | 12 | 28 | 141 |
| Binder Resin 6 | 367 | 230 | 163 | 20 | 12 | 227 | 123 |
| Binder Resin 7 | 469 | 137 | 152 | 4 | 75 | 114 | 107 |
| Binder Resin 8 | 265 | 323 | 262 | 20 | 12 | 57 | 114 |
| Binder Resin 9 | 60 | 509 | 144 | 4 | 12 | 284 | 103 |
| Binder Resin 10 | 367 | 230 | 163 | 20 | 12 | 227 | 108 |
| Binder Resin 11 | 367 | 230 | 278 | 20 | 12 | 28 | 149 |
| Binder Resin 12 | 265 | 323 | 278 | 20 | 12 | 28 | 148 |
| Binder Resin 13 | 469 | 137 | 152 | 4 | 75 | 114 | 107 |
| Binder Resin 14 | 469 | 137 | 196 | 20 | 12 | 170 | 112 |
| Binder Resin 15 | 469 | 137 | 70 | 4 | 75 | 256 | 104 |
| Binder Resin 16 | 367 | 230 | 158 | 4 | 59 | 142 | 95 |
| Binder Resin 17 | 60 | 509 | 278 | 20 | 12 | 28 | 114 |
| Binder Resin 18 | 265 | 323 | 152 | 4 | 75 | 114 | 102 |
| Binder Resin 19 | 469 | 137 | 70 | 4 | 75 | 256 | 103 |
| Binder Resin 20 | 469 | 137 | 269 | 4 | 28 | 28 | 109 |

Preparation of Composite Resin Particle Dispersion 1
Binder Resin 1: 141 parts
Binder Resin 6: 159 parts
Methyl Ethyl Ketone: 174 parts
Isopropanol: 47 parts
10% by Weight-Ammonia Aqueous Solution: 10.6 parts

Regarding the binder resin, insoluble matter is removed, and then the above components are put into a separable flask to mix and dissolve the components. After that, while the resultant material is heated and stirred at 40° C., ion exchange water is added dropwise at a liquid-supply rate of 8 g/min using a liquid supply pump. After the liquid becomes clouded, the liquid is subjected to phase inversion at a liquid-supply rate raised to 12 g/min, and the addition dropwise is stopped when the liquid supply amount is 1050 parts by weight. Thereafter, the solvent is removed under reduced pressure. Thus, a composite resin particle dispersion 1 is obtained.

The composite resin particle dispersion 1 has a volume average particle diameter of 168 nm and a solid content concentration of 30.6%.

Preparation of Composite Resin Particle Dispersions 2 to 25 and Resin Particle Dispersion 1

Composite resin particle dispersions 2 to 25 and a resin particle dispersion 1 are obtained in the same manner as in the case of the composite resin particle dispersion 1, except that the type and amount of the binder resin to be mixed, and the amounts of methyl ethyl ketone, isopropanol, and aqueous ammonia are changed as in the following Table 2.

TABLE 2

| | | | | | | | | Volume | |
|---|---|---|---|---|---|---|---|---|---|
| | | | Amount of | Amount of | Methyl | | | Average | |
| | | | Resin 1 | Resin 2 | Ethyl | | Aqueous | Particle | Solid Content |
| | | | Mixed | Mixed | Ketone | Isopropanol | Ammonia | Diameter | Concentration |
| | Resin 1 | Resin 2 | (parts) | (parts) | (parts) | (parts) | (parts) | (nm) | (% by weight) |
| Composite Resin | Binder Resin 1 | Binder Resin 6 | 141 | 159 | 174 | 47 | 10.6 | 168 | 30.6 |
| Particulate Dispersion 1 | | | | | | | | | |
| Composite Resin | Binder Resin 1 | Binder Resin 7 | 75 | 225 | 150 | 24 | 10.6 | 159 | 30.6 |
| Particulate Dispersion 2 | | | | | | | | | |
| Composite Resin | Binder Resin 2 | Binder Resin 7 | 90 | 210 | 170 | 29 | 10.3 | 159 | 31.3 |
| Particulate Dispersion 3 | | | | | | | | | |
| Composite Resin | Binder Resin 2 | Binder Resin 8 | 150 | 150 | 218 | 60 | 9.6 | 164 | 33.6 |
| Particulate Dispersion 4 | | | | | | | | | |
| Composite Resin | Binder Resin 2 | Binder Resin 9 | 210 | 90 | 197 | 56 | 9.9 | 165 | 29.6 |
| Particulate Dispersion 5 | | | | | | | | | |
| Composite Resin | Binder Resin 1 | Binder Resin 7 | 60 | 240 | 150 | 22 | 10.6 | 159 | 30.6 |
| Particulate Dispersion 6 | | | | | | | | | |
| Composite Resin | Binder Resin 3 | Binder Resin 10 | 180 | 120 | 194 | 59 | 10.2 | 170 | 29.6 |
| Particulate Dispersion 7 | | | | | | | | | |
| Composite Resin | Binder Resin 1 | Binder Resin 11 | 165 | 135 | 164 | 48 | 10.1 | 149 | 30.9 |
| Particulate Dispersion 8 | | | | | | | | | |
| Composite Resin | Binder Resin 1 | Binder Resin 12 | 99 | 201 | 150 | 50 | 10.6 | 165 | 35.1 |
| Particulate Dispersion 9 | | | | | | | | | |
| Composite Resin | Binder Resin 1 | Binder Resin 13 | 72 | 228 | 150 | 46 | 10.6 | 168 | 31.4 |
| Particulate Dispersion 10 | | | | | | | | | |
| Composite Resin | Binder Resin 2 | Binder Resin 14 | 105 | 195 | 188 | 31 | 9.6 | 165 | 30.6 |
| Particulate Dispersion 11 | | | | | | | | | |
| Composite Resin | Binder Resin 3 | Binder Resin 15 | 90 | 210 | 201 | 77 | 8.0 | 192 | 30.6 |
| Particulate Dispersion 12 | | | | | | | | | |
| Composite Resin | Binder Resin 1 | Binder Resin 2 | 30 | 270 | 211 | 59 | 9.7 | 164 | 29.1 |
| Particulate Dispersion 13 | | | | | | | | | |
| Composite Resin | Binder Resin 3 | Binder Resin 16 | 120 | 180 | 162 | 20 | 10.6 | 173 | 30.6 |
| Particulate Dispersion 14 | | | | | | | | | |
| Composite Resin | Binder Resin 3 | Binder Resin 6 | 240 | 60 | 183 | 45 | 10.6 | 172 | 30.6 |
| Particulate Dispersion 15 | | | | | | | | | |
| Composite Resin | Binder Resin 1 | Binder Resin 17 | 30 | 270 | 132 | 5 | 9.7 | 161 | 33.4 |
| Particulate Dispersion 16 | | | | | | | | | |
| Composite Resin | Binder Resin 2 | Binder Resin 11 | 105 | 195 | 193 | 50 | 9.6 | 141 | 30.6 |
| Particulate Dispersion 17 | | | | | | | | | |
| Composite Resin | Binder Resin 3 | Binder Resin 18 | 90 | 210 | 159 | 26 | 10.6 | 167 | 30.6 |
| Particulate Dispersion 18 | | | | | | | | | |
| Composite Resin | Binder Resin 3 | Binder Resin 15 | 270 | 30 | 111 | 32 | 6.0 | 106 | 30.6 |
| Particulate Dispersion 19 | | | | | | | | | |
| Composite Resin | Binder Resin 4 | Binder Resin 19 | 165 | 135 | 204 | 80 | 8.4 | 160 | 30.6 |
| Particulate Dispersion 20 | | | | | | | | | |
| Composite Resin | Binder Resin 2 | Binder Resin 11 | 60 | 240 | 188 | 48 | 9.6 | 136 | 30.6 |
| Particulate Dispersion 21 | | | | | | | | | |
| Composite Resin | Binder Resin 3 | Binder Resin 20 | 120 | 180 | 180 | 45 | 10.6 | 172 | 30.6 |
| Particulate Dispersion 22 | | | | | | | | | |
| Composite Resin | Binder Resin 3 | Binder Resin 6 | 180 | 120 | 186 | 45 | 10.6 | 172 | 30.6 |
| Particulate Dispersion 23 | | | | | | | | | |
| Composite Resin | Binder Resin 5 | Binder Resin 4 | 90 | 210 | 150 | 23 | 9.6 | 151 | 30.6 |
| Particulate Dispersion 24 | | | | | | | | | |
| Composite Resin | Binder Resin 5 | Binder Resin 11 | 240 | 60 | 180 | 45 | 9.6 | 129 | 30.6 |
| Particulate Dispersion 25 | | | | | | | | | |
| Resin Particulate | Binder Resin 1 | — | 300 | — | 150 | 50 | 10.6 | 165 | 30.6 |
| Dispersion 1 | | | | | | | | | |

Preparation of Release Agent Dispersion
Paraffin Wax HNP9 (manufactured by Nippon Seiro Co., Ltd.): 500 parts
Anionic Surfactant (manufactured by Dai-Ichi Kogyo Seiyaku Co., Ltd.: Neogen RK): 50 parts
Ion Exchange Water: 1700 parts

The above components are heated to 110° C. and dispersed using a homogenizer (manufactured by IKA Works GmbH & Co. KG: ULTRA TURRAX T50). Then, dispersion is performed by a Manton Gaulin high-pressure homogenizer (manufactured by Manton Gaulin Mfg. Co., Inc.) to prepare a release agent dispersion (release agent concentration: 31.1% by weight) in which a release agent having an average particle diameter of 0.180 μm is dispersed.

Preparation of Bright Pigment Particle Dispersion
Aluminum Pigment (manufactured by Showa Aluminum Powder K. K., 2173EA): 100 parts
Anionic Surfactant (manufactured by Dai-Ichi Kogyo Seiyaku Co., Ltd., Neogen R): 1.5 parts
Ion Exchange Water: 900 parts

A solvent is removed from the paste of the aluminum pigment, and then the above components are mixed and dissolved. The resultant material is dispersed for about 1 hour using an emulsification dispersing machine Cavitron (manufactured by Pacific Machinery & Engineering Co., Ltd., CR1010), whereby a bright pigment particle dispersion (solid content concentration: 10%) in which bright pigment particles (aluminum pigment) are dispersed is prepared.

Preparation of Toner 1
Composite Resin Particle Dispersion 1: 450 parts
Release Agent Dispersion: 50 parts
Bright Pigment Particle Dispersion: 220 parts
Nonionic Surfactant (IGEPAL CA897): 1.40 parts

The above raw materials are put into a 2 L-cylindrical stainless-steel container, and are dispersed and mixed for 10 minutes while applying a shearing force at 4,000 rpm by the use of a homogenizer (manufactured by IKA Works GmbH & Co. KG, ULTRA TURRAX T50). Then, 1.75 parts of a 10% nitric acid aqueous solution of polyaluminum chloride as an aggregating agent are gradually added dropwise, and the resultant material is dispersed and mixed for 15 minutes at a homogenizer rotation speed set to 5,000 rpm, whereby a raw material dispersion is obtained.

Thereafter, the raw material dispersion is put into a polymerization kettle provided with a stirring device using a stirring blade with two paddles for forming a laminar flow and a thermometer, and the heating is started at a stirring rotation speed set to 873 rpm by the use of a mantle heater to promote the growth of aggregated particles at 54° C. At this time, the pH of the raw material dispersion is controlled to be in the range of from 2.2 to 3.5 with a 0.3 N nitric acid or a 1 N aqueous sodium hydroxide. The resultant material is held for about 2 hours within the above pH range to form aggregated particles.

Next, 100 parts of a composite binder resin dispersion 1 is added thereto to adhere resin particles of the binder resin to the surfaces of the aggregated particles. The temperature is further increased to 56° C. and the aggregated particles are arranged while checking the size and shape of the particles using an optical microscope and the Multisizer II.

Thereafter, the pH is raised to 8.0 by adding 0.5 mol/L aqueous sodium hydroxide solution in order to merge the aggregated particles, and then the temperature is increased to 67.5° C.

After confirming that the aggregated particles are merged using the optical microscope, the pH is lowered to 6.0 by adding 0.3 mol/L nitric acid while maintaining the temperature at 67.5° C., the heating is stopped after 1 hour, and the resultant material is cooled at a rate of temperature decrease of 1.0° C./min. Thereafter, the resultant material is sieved with a 20 μm-mesh, is repeatedly washed with water, and is then dried using a vacuum dryer, whereby toner particles are obtained. The volume average particle diameter of the obtained toner 1 is 12.2 μm.

Preparation of Toners 2 to 35

Toners 2 to 35 are prepared in the same manner as in the case of the toner 1, except that the composite resin particle dispersion and resin particle dispersion to be used, the stirring rotation speed during aggregation, and the coalescence temperature are changed as in the following Table 3.

TABLE 3

| | | Stirring | |
|---|---|---|---|
| | | Speed During | Coalescence |
| | | Aggregation | Temperature |
| | | (rpm) | (° C.) |
| Toner 1 | Composite Resin Particulate Dispersion 1 | 873 | 67.5 |
| Toner 2 | Composite Resin Particulate Dispersion 1 | 807 | 70 |
| Toner 3 | Composite Resin Particulate Dispersion 1 | 890 | 63 |
| Toner 4 | Composite Resin Particulate Dispersion 2 | 873 | 67.5 |
| Toner 5 | Composite Resin Particulate Dispersion 3 | 873 | 67.5 |
| Toner 6 | Composite Resin Particulate Dispersion 4 | 873 | 67.5 |
| Toner 7 | Composite Resin Particulate Dispersion 5 | 873 | 67.5 |
| Toner 8 | Composite Resin Particulate Dispersion 6 | 873 | 67.5 |
| Toner 9 | Composite Resin Particulate Dispersion 7 | 873 | 67.5 |
| Toner 10 | Composite Resin Particulate Dispersion 8 | 873 | 67.5 |
| Toner 11 | Composite Resin Particulate Dispersion 9 | 873 | 67.5 |
| Toner 12 | Composite Resin Particulate Dispersion 10 | 873 | 67.5 |
| Toner 13 | Composite Resin Particulate Dispersion 11 | 873 | 67.5 |
| Toner 14 | Composite Resin Particulate Dispersion 12 | 890 | 65 |
| Toner 15 | Composite Resin Particulate Dispersion 13 | 890 | 65 |
| Toner 16 | Composite Resin Particulate Dispersion 14 | 807 | 67 |
| Toner 17 | Composite Resin Particulate Dispersion 15 | 890 | 65 |
| Toner 18 | Composite Resin Particulate Dispersion 16 | 807 | 67 |
| Toner 19 | Composite Resin Particulate Dispersion 17 | 890 | 65 |
| Toner 20 | Composite Resin Particulate Dispersion 18 | 807 | 67 |
| Toner 21 | Composite Resin Particulate Dispersion 19 | 890 | 65 |
| Toner 22 | Composite Resin Particulate Dispersion 20 | 807 | 67 |
| Toner 23 | Composite Resin Particulate Dispersion 21 | 890 | 65 |
| Toner 24 | Composite Resin Particulate Dispersion 22 | 807 | 67 |
| Toner 25 | Composite Resin Particulate Dispersion 23 | 890 | 65 |
| Toner 26 | Composite Resin Particulate Dispersion 24 | 807 | 67 |
| Toner 27 | Composite Resin Particulate Dispersion 25 | 890 | 65 |
| Toner 28 | Composite Resin Particulate Dispersion 1 | 706 | 73.5 |
| Toner 29 | Composite Resin Particulate Dispersion 1 | 778 | 70 |
| Toner 30 | Composite Resin Particulate Dispersion 1 | 1029 | 63.5 |
| Toner 31 | Composite Resin Particulate Dispersion 1 | 1326 | 61 |
| Toner 32 | Composite Resin Particulate Dispersion 1 | 563 | 80 |
| Toner 33 | Composite Resin Particulate Dispersion 1 | 695 | 73.5 |
| Toner 34 | Composite Resin Particulate Dispersion 1 | 1326 | 61 |
| Toner 35 | Resin Particle Dispersion 1 | 873 | 67.5 |

Preparation of Toner 36
Binder Resin 1: 211 parts
Binder Resin 6: 239 parts
Aluminum Pigment (manufactured by Showa Aluminum Powder K. K., 2173EA): 22 parts
Paraffin Wax HNP9 (manufactured by Nippon Seiro Co., Ltd.): 15.6 parts

The above components are weighed and then mixed using a 75 L-Henschel mixer (manufactured by Mitsui Miike Machinery Co., Ltd). The obtained mixture is heated and melted, and further kneaded using a screw extruder TEM48BS (manufactured by Toshiba Machine Co., Ltd.). After the kneading is completed, the obtained kneaded material is cooled and solidified. Initially, the solidified material is cracked by a pin crusher and fractured (average diameter: 300 μm) by a hammer mill. Next, using a fluidized-bed pulverizer AFG400 (manufactured by Alpine GmbH), the fractured material is pulverized. After the pulverization is completed, the obtained pulverized particles are classified in an inertia type classifier EJ30 to remove the fine particles and coarse particles, and thus a toner 36 is obtained.

Measurement

Of the obtained toner, the “ratio (A/B)”, the “ratio (C/D) of an average maximum thickness C of the toner to an average equivalent circle diameter D”, and the “when the toner is observed in cross-section in a thickness direction, the number of pigment particles in which the angle between a long-axis direction in the cross-section of the toner and a long-axis direction of the pigment particles is from −30° to +30° (hereinafter, called “the number of pigment particles of ±30° in range”) among the entire observed pigment particles” are measured by the above-described methods.

In addition, of the obtained toner, the THF-soluble component is subjected to the GPC measurement to measure the “molecular weight at the main peak”, “molecular weight at the sub-peak or shoulder” that is higher in molecular weight than the main peak, and “weight ratio of the component distributed in a molecular weight range of from 100,000 to 1,000,000”. An HLC-8120 manufactured by TOSOH Corporation is used for GPO, a TSKgel Super HM-M column (15 cm) manufactured by Tosoh Corporation is used, tetrahydrofuran (THF) solvent is used for measurement, and the molecular weight is calculated by using a molecular weight calibration curve created using a monodisperse polystyrene standard sample.

Image Quality Evaluation

A developing machine DocuCentre-III C7600 manufactured by Fuji Xerox Co., Ltd is filled with a developer that is a sample, and solid images with a toner amount of 4.5 g/cm² and half-tone images each with an image density of 60% or 30% are formed on a recording sheet (OK Top Coat+, manufactured by Oji Paper Co., Ltd) at a fixing temperature of 190° C. and a fixing pressure of 4.0 kg/cm².

Evaluation Standard

Brilliance is visually confirmed and evaluated under the illumination for color observation (natural daylight illumination) based on JIS K 5600-4-3:1999 “General Testing methods for paints—Part 4: Visual characteristics of coated film—Section 3: Visual comparison of the colour”. In the evaluation, the sensation of granularity (effect of brilliantly shining) and the optical effect (variation in hue according to the angle of view) are evaluated and the evaluation result is expressed in the following levels. Level 2 or higher is acceptable in practice.

5: The sensation of granularity and the optical effect are balanced.

4: There is a slight sensation of granularity and a slight optical effect.

3: There is a normal sensation.

2: Fogging is given.

1: There is no sensation of granularity and no optical effect.

The results are shown in the following Table 4.

TABLE 4

| | | | | | Weight Ratio in | Number of | | Image Quality Evaluation | | |
|---|---|---|---|---|---|---|---|---|---|---|
| | | | | | Molecular Weight | Pigment | | | Half-Tone | Half-Tone |
| | | | | Molecular | Range of from | Particles | | | Image | Image |
| | | | Molecular | Weight at | 100,000 to | of ±30° in | | | with Image | with Image |
| | | | Weight at | Sub-Peak/ | 1,000,000 | Range | | Solid | Density | Density |
| | Toner | A/B | Main Peak | Shoulder | (%) | (%) | C/D | Image | of 60% | of 30% |
| Example 1 | Toner 1 | 69 | 12700 | 788000 | 12.3 | 85 | 0.050 | 5 | 5 | 5 |
| Example 2 | Toner 2 | 61 | 12700 | 788000 | 12.3 | 80 | 0.075 | 5 | 5 | 5 |
| Example 3 | Toner 3 | 78 | 12700 | 788000 | 12.3 | 94 | 0.045 | 5 | 5 | 5 |
| Example 4 | Toner 4 | 69 | 10100 | 265000 | 10.4 | 85 | 0.050 | 5 | 5 | 5 |
| Example 5 | Toner 5 | 69 | 10900 | 420000 | 14.3 | 85 | 0.050 | 5 | 5 | 5 |
| Example 6 | Toner 6 | 69 | 14800 | 346000 | 10.6 | 85 | 0.050 | 5 | 5 | 5 |
| Example 7 | Toner 7 | 69 | 14400 | 483000 | 14.5 | 85 | 0.050 | 5 | 5 | 5 |
| Example 8 | Toner 8 | 69 | 9800 | 280000 | 10.9 | 85 | 0.050 | 5 | 4 | 4 |
| Example 9 | Toner 9 | 69 | 9700 | 579000 | 14.7 | 85 | 0.050 | 5 | 4 | 4 |
| Example 10 | Toner 10 | 69 | 15700 | 546000 | 10.3 | 85 | 0.050 | 5 | 4 | 4 |
| Example 11 | Toner 11 | 69 | 15500 | 810000 | 14.5 | 85 | 0.050 | 5 | 4 | 4 |
| Example 12 | Toner 12 | 69 | 10200 | 198000 | 9.0 | 85 | 0.050 | 5 | 5 | 4 |
| Example 13 | Toner 13 | 69 | 14500 | 271000 | 9.2 | 85 | 0.050 | 5 | 5 | 4 |
| Example 14 | Toner 14 | 69 | 10400 | 595000 | 16.4 | 90 | 0.045 | 5 | 5 | 4 |
| Example 15 | Toner 15 | 69 | 14500 | 559000 | 15.3 | 90 | 0.045 | 5 | 5 | 4 |
| Example 16 | Toner 16 | 71 | 9500 | 361000 | 7.5 | 86 | 0.075 | 5 | 4 | 3 |
| Example 17 | Toner 17 | 69 | 9300 | 980000 | 19.4 | 90 | 0.045 | 5 | 4 | 3 |
| Example 18 | Toner 18 | 71 | 16300 | 143000 | 7.9 | 86 | 0.075 | 5 | 4 | 3 |
| Example 19 | Toner 19 | 69 | 16900 | 965000 | 19.2 | 90 | 0.045 | 5 | 4 | 3 |
| Example 20 | Toner 20 | 71 | 8600 | 300000 | 7.6 | 86 | 0.075 | 5 | 3 | 3 |
| Example 21 | Toner 21 | 69 | 8700 | 825000 | 18.4 | 90 | 0.045 | 5 | 3 | 3 |
| Example 22 | Toner 22 | 71 | 17400 | 147000 | 7.4 | 86 | 0.075 | 5 | 3 | 3 |
| Example 23 | Toner 23 | 69 | 17400 | 1050000 | 19.8 | 90 | 0.045 | 5 | 3 | 3 |
| Example 24 | Toner 24 | 71 | 7100 | 355000 | 7.5 | 86 | 0.075 | 5 | 3 | 2 |
| Example 25 | Toner 25 | 69 | 7900 | 1100000 | 20.0 | 90 | 0.045 | 5 | 3 | 2 |
| Example 26 | Toner 26 | 71 | 19700 | 199000 | 7.8 | 86 | 0.075 | 5 | 3 | 2 |
| Example 27 | Toner 27 | 69 | 19300 | 617000 | 16.4 | 90 | 0.045 | 5 | 3 | 2 |
| Example 28 | Toner 28 | 45 | 12700 | 788000 | 12.3 | 73 | 0.140 | 4 | 4 | 4 |
| Example 29 | Toner 29 | 58 | 12700 | 788000 | 12.3 | 80 | 0.090 | 4 | 4 | 4 |
| Example 30 | Toner 30 | 81 | 12700 | 788000 | 12.3 | 93 | 0.019 | 4 | 4 | 4 |
| Example 31 | Toner 31 | 88 | 12700 | 788000 | 12.3 | 98 | 0.003 | 4 | 4 | 4 |
| Example 32 | Toner 32 | 3 | 12700 | 788000 | 12.3 | 60 | 0.340 | 3 | 3 | 3 |
| Example 33 | Toner 33 | 43 | 12700 | 788000 | 12.3 | 73 | 0.150 | 3 | 3 | 3 |
| Example 34 | Toner 34 | 93 | 12700 | 788000 | 12.3 | 98 | 0.003 | 3 | 3 | 3 |
| Comparative | Toner 36 | 1.2 | 12700 | 788000 | 12.3 | 12 | 0.880 | 2 | 1 | 1 |
| Example 1 | | | | | | | | | | |
| Comparative | Toner 35 | 43 | 11016 | — | 0.0 | 73 | 0.150 | 5 | 2 | 1 |
| Example 2 | | | | | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
bright pigment particles; and
a binder resin,
and the electrostatic charge image developing toner has a main peak and at least one peak or shoulder that is higher in molecular weight than the main peak, in a molecular weight distribution of a tetrahydrofuran-soluble component that is obtained through gel permeation chromatography measurement, and satisfies the following formula:
2≦A/B≦100
wherein A is reflectance at an acceptance angle of +30° that is measured when a solid image is formed using an electrostatic charge image developing toner and the image is irradiated with incident light at an incidence angle of −45° by the use of a variable-angle photometer, and B is reflectance at an acceptance angle of −30° that is measured when the image is irradiated with incident light at an incidence angle of −45° by the use of a variable-angle photometer.

2. The electrostatic charge image developing toner according to claim 1,
wherein the electrostatic charge image developing toner has the main peak in a molecular weight range of from 7,000 to 20,000, and at least one peak or shoulder other than the main peak in a molecular weight range of 100,000 or more, and
a weight ratio in a molecular weight range of from 100,000 to 1,000,000 of the electrostatic charge image developing toner is from 7% to 20%.

3. The electrostatic charge image developing toner according to claim 1,
wherein the electrostatic charge image developing toner has the main peak in a molecular weight range of from 8,000 to 19,000.

4. The electrostatic charge image developing toner according to claim 1,
wherein an average equivalent circle diameter D is longer than an average maximum thickness C in the toner particles, and
when a cross-section of the toner in a thickness direction is observed, the number of pigment particles in which an angle between a long-axis direction in the cross-section of the toner and a long-axis direction of the pigment particles is from −30° to +30° is at least about 60% of the observed total pigment particles.

5. The electrostatic charge image developing toner according to claim 1,
wherein the electrostatic charge image developing toner satisfies the following formula:
45≦A/B≦90.

6. The electrostatic charge image developing toner according to claim 4,
wherein a ratio (C/D) of the average maximum thickness C to the average equivalent circle diameter D is from 0.001 to 0.500.

7. The electrostatic charge image developing toner according to claim 4,
wherein a ratio (C/D) of the average maximum thickness C to the average equivalent circle diameter D is from 0.01 to 0.20.

8. An electrostatic charge image developer comprising:
the electrostatic charge image developing toner according to claim 1.

9. The electrostatic charge image developer according to claim 8,
wherein the electrostatic charge image developing toner has the main peak in a molecular weight range of from 7,000 to 20,000, and at least one peak or shoulder other than the main peak is in a molecular weight range of 100,000 or more, and
a weight ratio in a molecular weight range of from 100,000 to 1,000,000 of the electrostatic charge image developing toner is from 7% to 20%.

10. A toner cartridge comprising:
a toner accommodating chamber;
wherein the toner accommodating chamber contains the electrostatic charge image developing toner according to claim 1.

11. A process cartridge for an image forming apparatus comprising:
an image holding member; and
a developing unit that develops an electrostatic latent image formed on a surface of the image holding member by using a developer to form a toner image,
wherein the developer is the electrostatic charge image developer according to claim 8.

12. The process cartridge for an image forming apparatus according to claim 11,
wherein the electrostatic charge image developing toner has the main peak in a molecular weight range of from 7,000 to 20,000, and at least one peak or shoulder other than the main peak in a molecular weight range of 100,000 or more, and
a weight ratio in a molecular weight range of from 100,000 to 1,000,000 of the electrostatic charge image developing toner is from 7% to 20%.

13. An image forming apparatus comprising:
an image holding member;
a charging unit that charges a surface of the image holding member;
a latent image forming unit that forms an electrostatic latent image on the surface of the image holding member;
a developing unit that develops the electrostatic latent image formed on the surface of the image holding member by using a developer to form a toner image; and
a transfer unit that transfers the developed toner image onto a transfer member,
wherein the developer is the electrostatic charge image developer according to claim 8.

14. The image forming apparatus according to claim 13,
wherein the electrostatic charge image developing toner has the main peak in a molecular weight range of from 7,000 to 20,000, and at least one peak or shoulder other than the main peak in a molecular weight range of 100,000 or more, and
a weight ratio in a molecular weight range of from 100,000 to 1,000,000 of the electrostatic charge image developing toner is from 7% to 20%.

15. An image forming method comprising:
charging a surface of an image holding member;
forming an electrostatic latent image on the surface of the image holding member;
developing the electrostatic latent image formed on the surface of the image holding member by using a developer to form a toner image; and
transferring the developed toner image onto a transfer member,
wherein the developer is the electrostatic charge image developer according to claim 8.

16. The image forming method according to claim 15,
wherein the electrostatic charge image developing toner has the main peak in a molecular weight range of from 7,000 to 20,000, and at least one peak or shoulder other than the main peak in a molecular weight range of 100,000 or more, and
a weight ratio in a molecular weight range of from 100,000 to 1,000,000 of the electrostatic charge image developing toner is from 7% to 20%.
